(19) United States
(12) Patent Application Publication
(10) Pub. No.: US 2012/0256540 A1
(43) Pub. Date: Oct. 11, 2012

(54) LED LIGHTING APPARATUS WITH A BATTERY MONITORING DEVICE

(75) Inventors: Marcus John Batty, Stamford (GB); Philip Hutchings, Calne (GB)

(73) Assignee: RITELITE (SYSTEMS) LIMITED, Stamford, Lincolnshire (GB)

(21) Appl. No.: 13/517,998

(22) PCT Filed: Dec. 21, 2010
(86) PCT No.: PCT/GB2010/002299

§ 371 Date: Jun. 21, 2012

(30) Foreign Application Priority Data
Dec. 22, 2009 (GB) 0922370.2

(51) Int. Cl. H05B 37/02

(52) U.S. Cl. 315/33

(57) ABSTRACT

A portable lighting apparatus comprising a re-chargable battery and a plurality of LED's (light emitting diode) located on a PCB are housed in separate enclosures. The battery is managed by a first microprocessor in the battery enclosure and operation of the LED(s) is managed by a second microprocessor in the lamp enclosure. The two microprocessors are connected to respective data transmitters which generate signals to pass information and/or commands between the two microprocessors. The electrical systems of the two enclosures are interconnected by a bi-direction data link formed by a twin core cable.

### FIELD

This invention relates to a battery monitoring device for monitoring the use and condition of a battery of a portable LED lighting device.

### BACKGROUND OF THE INVENTION

Portable illumination devices of the type used for the illumination of buildings or work sites are well known and it is typical for the light source of the lamp to be separately housed from a battery container with the lamp being connected to the battery or batteries through a multi-core cable sometimes with the use of pin and socket connectors. In some cases the light source may comprise one or more LEDs and the battery may be connected to the light source through a electronic controller as is shown in EP1072493. In more sophisticated lighting equipment as is shown in CN201215298, the portable light may be provided with a electrical energy management system in which the battery is controlled through an electronic control circuit. Where LEDs are used as the light source they may be operated by driver chips located on a circuit board in the lamp housing.

The present invention provides an improved portable lamp in which the battery and lamp are housed in separate enclosures.

### STATEMENT OF INVENTION

According to the present Invention, there is provided a portable lighting apparatus in which a re-chargable battery and at least one LED (light emitting diode) are housed in separate enclosures, the battery being managed by a first microprocessor in a battery enclosure and the operation of the LED(s) being managed by a second microprocessor in a lamp enclosure, the two microprocessors being in communication to pass information and/or commands between the two microprocessors.

The apparatus may comprise a plurality of LED's which are located on a PCB.

Preferably the battery is a re-chargable battery.

Preferably, the first microprocessor forms part a battery module electrical system and the second microprocessor forms part of a lamp module electrical system, the two modules being interconnected by a bi-directional data link formed by a twin core cable.

The bi-directional data link may comprise a first switching device in the battery module electrical system and a second switching device in the lamp module electrical system for selecting a low impedance mode to transfer power to the lamp module electrical circuit and a high impedance mode for sending data between the two modules. Preferably, the switching devices comprise respective field effect transitors, more preferably N-channel metal oxide field effect transistors which may be wired into the negative channel in the electrical system.

In the high impedance mode a limited amount of DC power, preferably <0.1 Watts can be transferred from the battery to the lamp module electrical system to power the second microcontroller.

For a portable lighting apparatus according to the first aspect of the present invention, there is provided a method of controlling the transfer of power and data between the first and second microprocessors wherein the battery is connected to a battery module electrical system and the LED is connected to a lamp module electrical system and a bi-directional data link is provided by switching the battery module electrical system and the lamp module electrical system to select a low impedance mode to transfer power to the lamp module electrical circuit and a high impedance mode for sending data between the two modules.

### DESCRIPTION OF THE DRAWINGS

The Invention will be described by way of Example and with reference to the accompanying drawings in which:

FIG. 1 is an isometric view of a portable lamp apparatus also according to the present invention.

FIG. 2 is a schematic sectional drawing through the lamp module,

FIG. 3 is a block diagram of the electrical system for the lighting apparatus electrical system, and

FIG. 4 is a Flow diagram showing the operational sequence

### DETAILED DESCRIPTION OF THE INVENTION

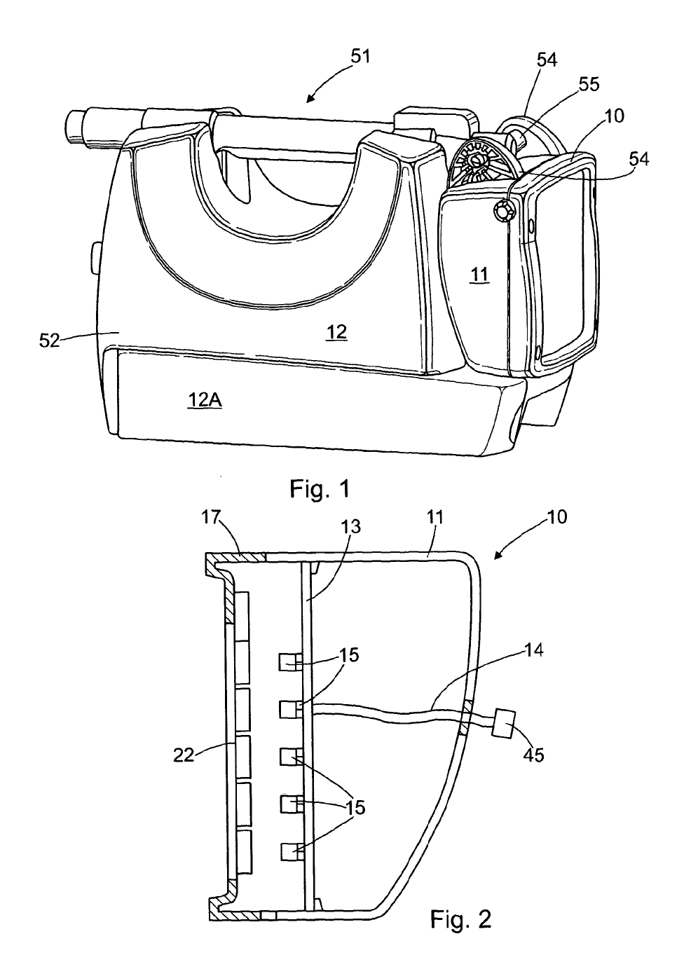

With reference to FIG. 1 and FIG. 2, there is shown a portable lighting apparatus 51 having a lamp module 10 and a battery module 12. The lamp module 10 has a separate lamp enclosure 11 and the battery module includes a battery enclosure 12 A. The lamp module 10 is mounted at one end of the battery module 12 and is attached to the battery module 12 by a pin 55 passing through lugs 54 on the battery enclosure 12A. This allows the lamp module 10 to be adjusted to different angles of orientation relative to the battery module 12.

The lamp module 10 comprises a moulded plastics enclosure 11 having a front cover 17 with a transparent central portion 22. The housing 11 has a PCB (Printed Circuit board) 13 mounted therein with twin core cable 14 connecting the PCB to a twin core connector 45 for connection to a battery module electrical system in the battery enclosure 12A. The PCB 13 includes an array of high output LED's 15 arranged in a desired array for example columns and rows. The electrical connector 45 between the battery module 12 and the lamp module 10 comprises two pins 43,44 and corresponding sockets (see below).

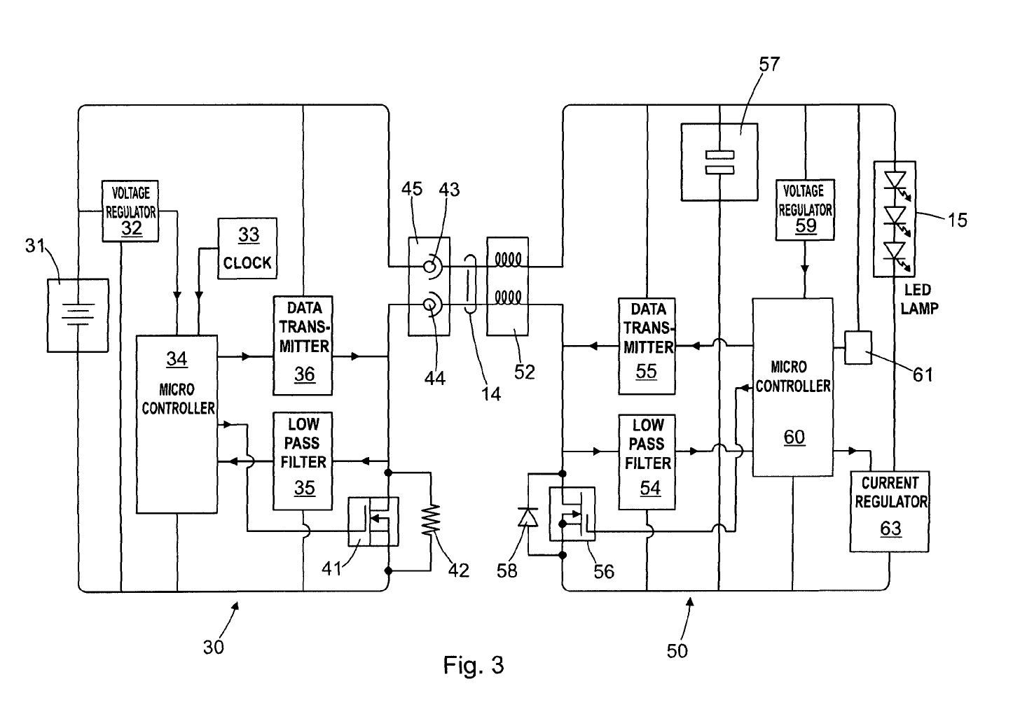

Now with reference to FIG. 3, there is shown a schematic diagram of a electrical system for the lighting apparatus and which comprises an electrical management system 30 for battery module 12 and a lamp module electrical system 50 which controls operation of the LEDs 15. In the electrical management system 30 for the battery module, a re-chargable battery 31 has its positive terminal connected to the positive pin 43 of the connector 45 to the lamp module electrical system 50 and its negative terminal connected to a negative pin 44 in the connector 45. A resistor 42, in the order of 1K ohm, is in series with the return to negative terminal and is connected in series with a switching device 41 which can allow the resistor 42 to be by-passed. The operation of the switching device 41 is controlled by a microprocessor 34.

The DC power from the battery is controlled by a voltage regulator 32 which provides a regulated power supply to the microprocessor 34. The microprocessor 34 is pre-programmed to manage the battery and monitors battery condition (charge state), controls re-charge, operates low charge state alarms (for example a suitably coloured LED), confirms correct battery type, and will disconnect the load on the battery to prevent damage due to excess discharge. To that end the microprocessor 34 is connected to a plurality of different sensors and devices which are represented by the crystal clock 33 which provide for timed intervals, preferably in the order of 1.0 second.

The microprocessor 34 is also connected to a data transmitter 36 which provides current pulses for transmitting data from the processor 34 to the lamp module electrical system 50. A low pass filter 35 is provided in the negative return to the microprocessor 34 to remove high frequency noise from data received from the lamp module as will be described later.

Such a system will be formed on a PCB housed in the battery enclosure 12A.

With reference now to the electrical management system 50 for the lamp module 10, this will be formed on the PCB 13. The positive socket 43 of connector 45 is connected to the LED array 15 through a low pass filter 52. The LED array is connected to the negative socket 44 of connector 45 through the low pass filter 52, via a current regulator 63 and in series with a switching device 56. The current regulator 63 controls and regulates the current to, and brightness of, the LEDs 15. The low-pass filter 52 attenuates noise from the current regulator 63.

The positive socket 43 is also connected to a microprocessor 60 through a voltage regulator 59. The microprocessor 60 is pre-programmed to control the LED illumination in line with battery charge and stores information in relation the operation of the LEDs and communicates with the battery microprocessor 34. The micro-processor 60 may also control operation other components associated with the illumination, for example, a diffuser.

The microprocessor 60 is connected to the switching device 56 and is also connected to the current regulator 63 and to a data transmitter 55 which provides current pulses for data transmission to the microprocessor 34 in the battery module.

An energy storage device 57 is provided in the electrical system to power the LED's 15 and/or microprocessor 60 when the battery system is in high impedance mode. The storage device 57 is charged by a diode 58 connected across the switching device 56. The diode 58 provides a circuit for the current from the resistor 42 to reach the energy storage device 57. The storage device 57 is charged to a peak voltage based on the forward voltage from the battery 31 minus the forward voltage drop of the diode 56.

The two switches 41 and 56 may be selected from suitable power switching transistors such as field effect transistors and Bipolar junction transistors and even relays. The preferred option is for the use of N-Channel metal oxide field effect transistors with the negative connection in series with the negative from the lamp.

The microprocessor 60 is also connected to a wireless 2.4 GHz transceiver 61 which can communicate with a remote control (not shown) which is based on the published IEEE 802.15.4 signaling protocol. The transceiver 61 is required to be available while the lamp module is in the OFF state when power consumption must be kept as low as possible.

The DC power to the transceiver 61 is cycled between the active (30 mA) and off (3 uA) states, once per second, so that the average power consumption when the lamp is OFF is within the acceptable off-state current load on the battery.

The two interconnected battery and lamp electrical systems 30 & 50 provide a bidirectional data link between the battery and the lamp modules, so that the lamp module can verify that a battery of the correct type for the lamp is used, as well as manage operation of the battery and pass date between the battery and lamp microprocessors 34 & 60.

The invention consists of switching the two interconnected systems using a twin wire connection 14 with the switches 41 & 56 to select either a low impedance power transfer mode, or a high impedance signalling mode, and uses a protocol to switch both ends between the two modes at the same time.

When the interconnected systems are in the Low Impedance Power Transfer mode, both switch 41 in the battery module and switch 56 in the lamp module are ON. In this mode, the energy storage device 57 in the lamp module is charged directly by the battery. In the low impedance power transfer mode, the circuit is used to convey a significant electrical power of the order of thirty Watts, to the LED,s and no signalling is possible.

In the High impedance signalling mode, the interconnected systems convey bidirectional signalling pulses allowing communication between the microprocessors 60 & 34 in the lamp module and the battery module respectively. When in the High Impedance Data Transfer mode, both switch 41 in the battery module and switch 56 in the lamp module are OFF. Only a limited amount of DC power, of the order of 0.1 Watts, can be transferred from the battery module to the lamp module, to provide power to the microcontroller 60, and the remote control receiver 61, which is located in the lamp module.

The energy storage device 57 is charged through resistor 42 in the battery module and the reverse body Diode 58. In both the High Impedance data Transfer mode, or the Low Impedance Power Transfer Mode, DC power from the battery is supplied to the energy storage device 57, which supplies power to the microprocessor 60 via the regulator 59.

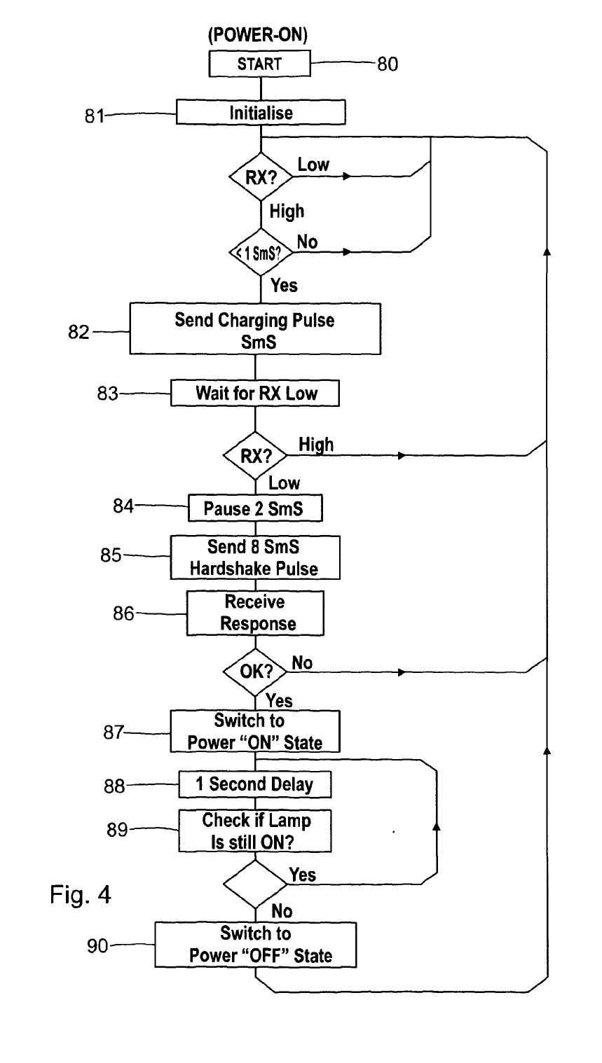

Now with reference to FIG. 4 on start-up (when the user presses the ON button) in Step 80, typically on a remote control, the control transmits a series of command packets to the wireless transceiver 61 repeating every 4 mS for a timed maximum interval of 10 seconds. When the transceiver 61 in the LED lamp next switches ON, the receiver 61 detects the remote command and sends an acknowledge packet, which causes the remote control to stop sending. The circuit is by default in the High Impedance mode. In steps 81-84, the lamp module microprocessor 60 sends a series of signal pulses to the microprocessor 34 in the battery module which then replies with a series of pulses. Providing that this signalling is completed without error, as determined in steps 85 & 86, both switches 41 and 56 are switched ON and to the low impedance power delivery mode, step 87.

Further, in this arrangement there is a protocol in steps 88-90 for determining when the lamp has been switched off, and the battery should switch back to the high impedance state. In the present invention this is done in the Battery unit by testing the current draw step 89 after a timed interval Step 88, once per second. If the lighting apparatus is off, the system is switched back to high impedance mode in step 90.

Further to this power conservation method, is a method for indicating to the user the status of the battery in the lamp unit. One of the bytes in the acknowledge packet is varied according to the voltage of the battery in the battery module plugged into the lamp LED unit, using an A-D converter.

Then the LED indicator in the remote control signals the user by showing Green, Yellow, Red, or Flashing Red status, the need for charging the battery in the lamp unit, without requiring any further signalling.

1. A portable lighting apparatus comprising a battery housed in a battery enclosure and at least one LED housed in separate lamp enclosures, the battery being managed by a first microprocessor in the battery enclosure and operation of the at least one LED being managed by a second microprocessor in the lamp enclosure, the first and second microprocessors being connected to data transmitters which generate signals to pass information and/or commands between the microprocessors.

2. Apparatus as claimed in claim 1, wherein the at least one LED comprises a plurality of LED's located on a PCB.

3. Apparatus as claimed in claim 1, wherein the battery is re-chargable under management of the first microprocessor.

4. Apparatus as claimed in claim 1, further comprising a battery module electrical system including the first microprocessor, and a lamp module electrical system including the second microprocessor, the systems being interconnected by a bi-direction data link comprising a twin core cable.

5. Apparatus as claimed in claim 4, wherein the bi-directional data link comprises a first switching device in the battery module electrical system and a second switching device in the lamp module electrical system for selecting a low impedance mode to transfer power to the lamp module electrical system and a high impedance mode for sending data between the microprocessors.

6. Apparatus as claimed in claim 5, wherein the first switching circuit is arranged in parallel with a high value resistor and the resistor is arranged in series with an LED circuit when the first switching device is off.

7. Apparatus as claimed in claim 6, wherein the second switching device is arranged in parallel with a reverse body diode to allow a minimum power flow to the second microprocessor when the second switching device is off and the first switching device is in a high impedance mode, both switching devices being ON in a low impedance mode.

8. Apparatus as claimed in claim 5, wherein each switching devices comprises a respective field effect transistors.

9. Apparatus as claimed in claim 8, wherein each field effect transistor comprises an N-channel metal oxide field effect transistors.

10. Apparatus as claimed in claim 5, wherein, in the high impedance mode, a minimum amount of DC power <0.1 Watts is transferred to power the second microprocessor.

11. Apparatus as claimed in claim 5, wherein, in low impedance mode, a DC power of about 30 watts is transferred to power the at least one LED.

12. Apparatus as claimed in claim 1, wherein the lamp module electrical system has a wireless receiver connected to the second microprocessor and the lighting apparatus is switched on by a remote control sending a signal to the second microprocessor to initiate data transfer between the processors.

13. A method of controlling transfer of power and data between the first and second microprocessors of the lighting apparatus of claim 1, comprising: using a bi-directional data link and switching an electrical system of the apparatus to select a low impedance mode to transfer power to the at least one LED and a high impedance mode for sending data between the two microprocessors.
